(19) United States
(12) Patent Application Publication
(10) Pub. No.: US 2011/0043370 A1
(43) Pub. Date: Feb. 24, 2011

(54) Animated logo for a portable computer

(75) Inventors: Mahyar Vahabzadeh, Phoenix, AZ (US); David Martin Lipari, Gilbert, AZ (US)

Correspondence Address: Poul F. Wille;Cantor Colburn LLP, 20 Church St. 22nd Floor, Hartford, CT, 06103-3207, US

(73) Assignee: World Properties, Inc., Lincolnwood, IL (US)

(21) Appl. No.: 12/583,257

(22) Filed: Aug. 18, 2009

(51) Int. Cl. H05B 37/02; F21V 33/00; G08B 5/22

(52) U.S. Cl. 340/815.4; 362/253; 315/312; 361/679.26

(57) ABSTRACT

A portable computer comprises a housing and an EL panel within the housing, positioned to emit light outwardly from the housing. The EL panel includes a plurality of EL lamps that, together, form a logo. The EL lamps can be addressed separately, enabling one to produce the appearance of motion for decorative effect or to indicate a condition of the portable computer or both.

### FIELD OF THE INVENTION

This invention relates to thick film electroluminescent (EL) lamps and, in particular, to an EL panel in the form of a logo in a portion of a case for a portable electronic device, such as a portable computer.

### GLOSSARY

As used herein, an EL “panel” is a single substrate including one or more luminous areas, wherein each luminous area is an EL “lamp.”

A “thick film” EL lamp refers to one type of EL lamp and “thin film” EL lamp refers to a different type of EL lamp. The terms only broadly relate to actual thickness and actually identify distinct disciplines. A thin, thick film EL lamp is not a contradiction in terms and such a lamp is considerably thicker than a thin film EL lamp. Thick film EL is generally based upon inks deposited on a substrate, wherein the inks contain solvent, binder and filler. The filler determines the nature of the film; phosphor, dielectric, or conductor.

A “phosphor layer” is not restricted to a single phosphor and does not exclude cascading phosphors or dyes for color enhancement.

A “graphic” can be text, a symbol, an arbitrary shape, or some combination thereof. A graphic can be translucent, shaded, colored, a silhouette or outline, or some combination thereof.

A “logo” is a graphic that is a symbol of or a trademark for a person (legal or natural), a group of people, a service, a place, or a thing. “Logo” includes a defined field, if any, surrounding or highlighting the symbol or trademark.

“Opaque” does not mean that no light is transmitted, only that the amount of light transmitted is substantially reduced, e.g. to ten percent of incident light.

“Obscure” might be another term.

“Transparent” does not mean that all light is transmitted, only that enough light is transmitted to recognize a graphic.

A “portable computer” is a system containing a keyboard, display, and microprocessor chip set, inside a single enclosure or housing. The enclosure is typically two pieces or shells hinged along one edge and opening to reveal the display in one half and the keyboard in the other half. “Enclosure” does not necessarily mean fully enclosed. “Portable computer” is generic to “notebook”, “netbook”, “laptop” or other terms for lightweight, compact systems.

A “flat panel display” is any display that is relatively thin compared with the dimensions of the display area.

In general, all words are used without resort to extreme interpretation or to semantics at the expense of reality. The words are used within their ordinary meaning, either in everyday speech or as jargon in a particular technology, as appropriate.

### BACKGROUND OF THE INVENTION

An EL lamp is essentially a capacitor having a dielectric layer between two conductive electrodes, one of which is transparent. The dielectric layer includes phosphor or there is a separate layer of phosphor adjacent the dielectric layer. The phosphor emits light in the presence of a strong electric field, using very little current. The light is substantially uniform across the area of the lamp and the lamp is relatively thin, making it desirable for back lighting displays, for which EL lamps have long been used.

Animated displays using EL lamps are old in the art; e.g. see U.S. Pat. No. 2,773,216 (Edmonds) and U.S. Pat. No. 6,205,690 (Heropoulos et al.).

Most portable computers have opaque logos on the upper half of their enclosure. Back lit logos for portable computers are known in the art; e.g. see U.S. Pat. No. 6,977,808 (Lam et al.). Back lit or not, the logo is not particularly eye-catching.

A difficulty with the construction described in the '808 patent, aside from cost and complexity, is that the logo is lit only to the extent that the display is active. If the display is dimmed or turned off, the logo is dimmed or turned off; e.g. when attaching an external display or when the computer is in a low power (“sleep”) mode or turned off.

Another difficulty is that the logo is monochromatic, derived from the light from the display itself, averaged over all the pixels of various colors.

It is known in the art to use a logo on a cellular telephone to indicate connection to a wireless network; see U.S. Patent Application Publication No. 2004/0204151 (Muthuswamy et al.). U d as an indicator, the logo is dark when there is no connection, making the logo difficult to see at least some of the time, which is undesirable.

It is known in the art to provide a secondary display in the cover of a closed device; e.g. U.S. Patent Application Publications 2008/0074899 and 2008/0076253.

It is known in the art how to mold an EL lamp as integral part of a component; see U.S. Patent Application Publication 2005/0067952 (Fechter et al.), which is incorporated herein by reference. Molding EL lamps into three dimensional shapes is also known in the art; see the patents discussed in the Background portion of the Publication.

In view of the foregoing, it is therefore an object of the invention to provide a back lit logo for a portable computer, wherein the logo is illuminated independently of the display in the computer.

Another object of the invention is to provide a luminous, animated logo for portable computers.

A further object of the invention is to provide a luminous, animated logo for portable computers that conveys information about the state of the portable computer.

Another object of the invention is to provide an animated EL panel in the shape of a logo.

A further object of the invention is to back light a logo with an animated EL panel.

### SUMMARY OF THE INVENTION

The foregoing objects are achieved by the invention in which a portable computer comprises a housing and an EL panel within the housing itself, positioned to emit light outwardly from the housing. The EL panel includes a plurality of EL lamps that, together, form a logo. The EL lamps can be addressed separately, enabling one to produce the appearance of motion for decorative effect or to indicate a condition of the portable computer or both.

### BRIEF DESCRIPTION OF THE DRAWINGS

A more complete understanding of the invention can be obtained by considering the following detailed description in conjunction with the accompanying drawings, in which:

FIG. 1 is a perspective view of a portable computer having a logo in the upper shell of the enclosure;

FIG. 2 is a plan view of the upper shell of a portable computer constructed in accordance with a preferred embodiment of the invention;

FIG. 3 is a cross-section of a shell for a portable computer illustrating a first embodiment of the invention;

FIG. 4 is a cross-section of a shell for a portable computer illustrating a first embodiment of the invention;

FIG. 5 is a cross-section of a shell for a portable computer illustrating a second embodiment of the invention; and

FIG. 6 is a cross-section of a shell for a portable computer illustrating a third embodiment of the invention; and

FIG. 7 is a perspective view of a portable computer having a logo in the lower shell of the enclosure.

The figures are not drawn to scale but merely illustrate various aspects of the invention.

### DETAILED DESCRIPTION OF THE INVENTION

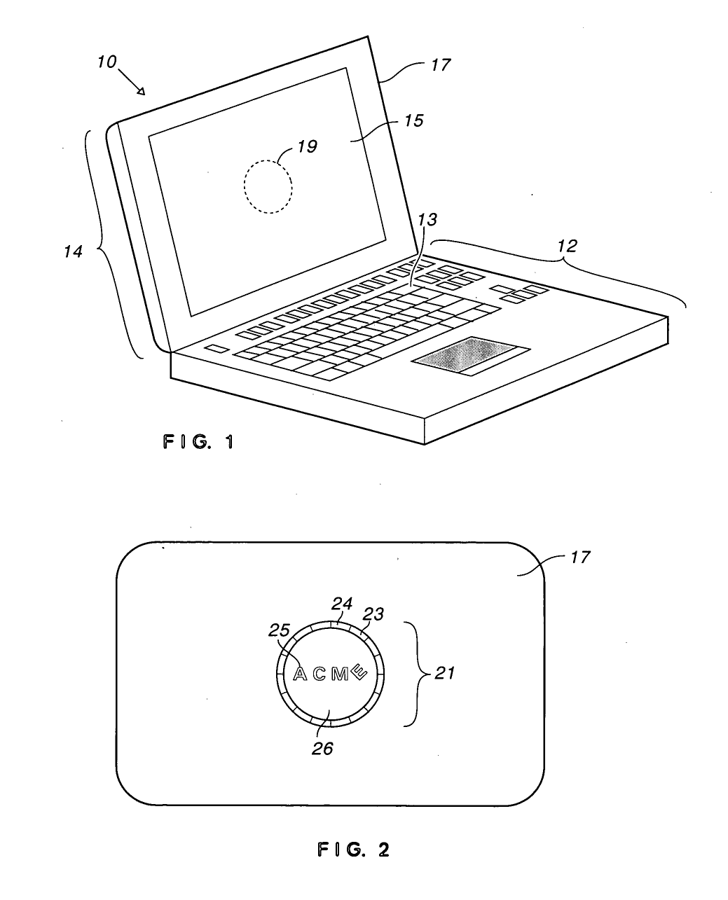

In FIG. 1, personal computer 10 includes base 12 and display unit 14. Base 12 includes keyboard 13 and suitable electronics such as a microprocessor, input/output ports, wireless communication, battery, charger, and power supply. Display unit 14 contains flat panel display 15 in the volume defined by shell 17. Flat panel display 15 emits light toward a viewer, across keyboard 13. In accordance with one aspect of the invention, shell 17 defines logo site 19 for an EL panel that emits light in a direction opposite to that of display 15.

In FIG. 2, shell 17 includes EL panel 21 approximately centrally located within the shell itself; i.e., EL panel 21 is part of the structure of shell 17, as opposed to being contained within the volume defined by the shell. EL Panel 21 need not be centrally located. EL panel 21 includes a plurality of lamps, such as lamps 23, 24, and 25. Lamps 23 and 24 are arcs of a circle surrounding a logo, represented by the letters “A,” “C,” “M,” and “E.” Each of the letters is preferably a separate lamp. Alternatively, lamp 25 could include all four letters. Area 26 may or may not include a lamp. If area 26 is a lamp, one has the opportunity to reverse the appearance of the logo, when the logo can be reversed photographically and remain a proper representation of a trademark. By “reverse” is meant interchanging light areas and dark areas.

In accordance with another aspect of the invention, the EL panel provides an indication of a condition within portable computer 10; e.g. temperature or level of battery charge. The indication can be by brightness, color, motion, progression, or some combination of these effects. The lamps forming the circle can be lit sequentially to indicate battery capacity, for example. The display can be static, as a speedometer or bar graph, or moving, where lamps are sequentially lit and remain lit until a maximum is reached and then the sequence begins again. The entire circle can represent one condition or a portion of the circle can be used; e.g. two arcs of 180° each, one arc for each condition.

In accordance with another aspect of the invention, decorative effects can be provided by powering the lamps in various combinations and sequences. Indication and decoration can be combined.

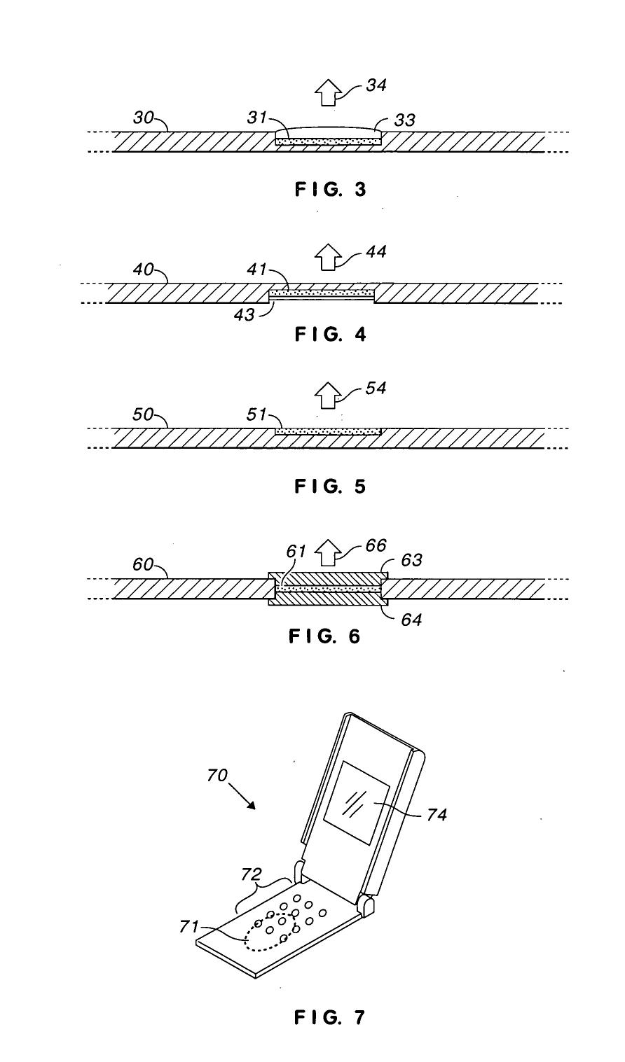

FIG. 3 illustrates a first embodiment of the invention in which shell 30 includes a recess in the outer surface thereof in which EL panel 31 rests. EL panel 31 is protected by cover 33 and emits light in the direction indicated by arrow 34. An aperture (not shown) allows conductive leads to be passed through shell 30 for connection to a source of power.

FIG. 4 illustrates a second embodiment of the invention in which shell 40 includes a recess in the inner surface thereof in which EL panel 41 rests. EL panel 41 is protected by cover 43 and emits light in the direction indicated by arrow 44 through a transparent portion of shell 40.

FIG. 5 illustrates a preferred embodiment of the invention in which EL panel 51 is molded into shell 50 in the manner described in U.S. Patent Application Publication 2005/0067952. EL panel 51 is placed in a mold and plastic is injected into the mold to form shell 50. The panel and shell are then a single unit. EL panel 51 emits light in the direction indicated by arrow 54. This embodiment enables one to produce economically a large number of shells bearing the same logo.

FIG. 6 illustrates an alternative embodiment of the invention in which the EL panel is sandwiched between two plates, at least one of which is transparent. EL panel 61 is located in a hole in shell 60 and is held in place by plates 63 and 64. For the sake of example, plate 63 is transparent and light is emitted in the direction shown by arrow 66. The plates are held in place by friction or adhesive. To increase contact area, the plates preferably include a shoulder extending over a portion of shell 60 around at least some of the perimeter of the hole. Either plate can serve as a substrate during the manufacture of EL panel 61 or EL panel 61 is laminated to one plate to facilitate handling during manufacture.

FIG. 7 illustrates an alternative embodiment of the invention. Logo 71 is on the outside of a shell containing keypad 72. Display 74 is located in the other half of electronic device 70.

The invention thus provides a back lit logo for a portable computer, wherein the logo is illuminated independently of the display in the computer. The logo can be animated and convey information about the state of the portable computer. Alternatively, a logo is back lit by an animated EL panel.

Having thus described the invention, it will be apparent to those of skill in the art that various modifications can be made within the scope of the invention. For example, although described in the context of a portable computer, the invention can be used with other electronic devices, e.g. desktop computers and cellular telephones. In any of the embodiments of the invention, the EL panel can be used to back light an opaque symbol or trademark.

What is claimed is:

1. A portable computer comprising:
a housing;
an EL panel within the housing itself and positioned to emit light outwardly from said housing;
said EL panel including a plurality of EL lamps, together forming a logo, wherein said EL lamps can be addressed separately.

2. The portable computer as set forth in claim 1 wherein said EL lamps operate in sequence to produce the appearance of motion.

3. The portable computer as set forth in claim 1 wherein said EL lamps operate in sequence to indicate a condition of the portable computer.

4. The portable computer as set forth in claim 1 wherein said EL lamps operate in a pattern to indicate a condition of the portable computer.

5. The portable computer as set forth in claim 1 wherein at least one of said EL lamps operates as long as the portable computer is not turned off.

6. A portable computer having a flat panel display that emits light in a first direction, said portable computer further comprising:
an outer shell for enclosing at least a rear portion of said flat panel display;
an EL panel within said outer shell itself and positioned to emit light from said outer shell in a second direction, opposite to said first direction;
said EL panel including a plurality of EL lamps, together forming a logo, wherein said EL lamps can be addressed separately.

7. The portable computer as set forth in claim 6 wherein said EL panel is formed as an integral part of said shell.

8. The portable computer as set forth in claim 6 wherein said EL panel is positioned within the outer surface of said shell and said portable computer includes a transparent, protective cover for said EL panel.

9. The portable computer as set forth in claim 6 wherein at least a portion of said shell is transparent and said EL panel is positioned to emit light through said transparent portion.

10. A portable electronic device comprising:
a base unit including at least one microprocessor;
a display unit including a flat panel display and a shell enclosing at least the rear portion of said flat panel display;
wherein at least a portion of said shell is transparent;
an EL panel within said shell and positioned to emit light outwardly from said shell;
said EL panel including a plurality of EL lamps that can be addressed separately.

11. The portable electronic device as set forth in claim 10 wherein said plurality of EL lamps form a logo.

12. The portable electronic device as set forth in claim 10 wherein said plurality of EL lamps back light an opaque logo.

13. The portable electronic device as set forth in claim 10 wherein said EL lamps operate in sequence under the control of said microprocessor to produce the appearance of motion.

14. The portable electronic device as set forth in claim 10 wherein said EL lamps operate in sequence under the control of said microprocessor to indicate a condition of the portable electronic device.

15. The portable electronic device as set forth in claim 10 wherein said EL lamps operate in a pattern under the control of said microprocessor to indicate a condition of the portable electronic device.
